(19) United States
(12) Patent Application Publication
(10) Pub. No.: US 2003/0188899 A1
(43) Pub. Date: Oct. 9, 2003

(54) Prepositive electro-magnetic tablet with transparent antenna

(76) Inventors: Ching-Chuan Chao, Taipei (TW); Chih-An Chen, Taipei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/118,371

(22) Filed: Apr. 9, 2002

(51) Int. Cl. G08C 21/00

(52) U.S. Cl. 178/18.03

(57) ABSTRACT

A structure of a prepositive electromagnetic tablet with a transparent antenna and the method for fabricating said prepositive electromagnetic tablet with a transparent antenna is disclosed. The electromagnetic tablet according to this present invention comprises a durable transparent substrate, a transparent antenna layer, and a transparent protective layer. Further, the above-mentioned electromagnetic tablet can be applied in front of LCD panel (at the user's side). Therefore, it is more convenient regarding the function of hand-written input and hand-written drawing, which can be directly performed on a displayer.

### BACKGROUND OF THE INVENTION

1. Field of the Invention

This present invention relates to an electro-magnetic tablet, and more particularly to a prepositive electro-magnetic tablet with transparent antenna.

2. Description of the Prior Art

In the prior art, with a tablet integrated type liquid crystal display (LCD) apparatus, the display apparatus and a tablet are formed independently, and the antenna layer of the tablet is disposed behind the LCD panel of LCD. A tablet integrated type LCD apparatus in prior art is shown in FIG. 1. Referring to FIG. 1, a durable transparent substrate 100 is placed in front of a LCD panel 110 (at the user's side). An antenna layer 120 and a shielding plate 130 are placed behind the LCD panel 110. In practice, the defect of the above-mentioned construction is that the outer cover of LCD must be dismantled for mounting and fixing the antenna layer 120 and the shielding plate 130 behind the LCD panel 110, i.e., an additive step for dismantling/emplacing of the outer cover in the process of mounting the antenna layer of tablet. Therefore, the afore-cited construction in the prior art is inconvenient for the emplacement of a tablet integrated type LCD.

Additionally, another defect, is a refracting angle between the electromagnetic wave from an electromagnetic pen 140 and the antenna layer 120, because the LCD panel 110 is positioned between the antenna layer 120 and the electromagnetic pen 140, wherein the LCD panel 110 is consisted with a thickness. The refracting angle will cause a parallax between the position of the electromagnetic pen 140 and the curser of a displayer. Moreover, the problem regarding a parallax is as serious as increasing the thickness of the LCD panel. Still another disadvantage of the above-mentioned construction is, a more powerful electromagnetic wave is necessary in retaining the performance of the tablet, because the electromagnetic pen 140 is away from the antenna layer 120.

Accordingly, under the tide of high integration, it is an important object, on how to provide a more convenient hand-writing apparatus.

### SUMMARY OF THE INVENTION

In accordance with the present invention, a prepositive electromagnetic tablet with a transparent antenna is provided for dispensing with the dismantling step in the prior art, during the emplacement of the tablet according to this invention to a monitor.

It is another object of this invention to provide a prepositive electromagnetic tablet with transparent antenna, and there is no parallax between an electromagnetic pen and the cursor of a monitor while using the electromagnetic tablet according to this invention.

Still another object of this invention is to provide a prepositive electromagnetic tablet with transparent antenna. Because the electromagnetic tablet according to this invention positioned in front of a LCD panel (the user's side), it is not necessary to employ a powerful electromagnetic wave, as in the prior art, to retain the performance of the tablet.

Still another object of this invention is to provide a prepositive electromagnetic tablet with a transparent antenna, wherein the electromagnetic tablet may be positioned in from of a LCD panel (at the user's side), and the function of hand-writing input or hand-writing drawing can be directly performed on a LCD.

Still another object of this invention is to provide a prepositive electromagnetic tablet with a transparent antenna, wherein the electromagnetic tablet comprises a transparent netted shielding layer, and the electromagnetic wave interference from the environment can be isolated during the utilization of the electromagnetic tablet according to this invention.

In accordance with the above-mentioned objects, the invention provides a prepositive electromagnetic tablet with a transparent antenna, wherein the electromagnetic tablet may be applied in front of a LCD panel (at the user's side), in order to directly perform the function, such as hand-written input, and hand-written drawing, on a monitor. The above-mentioned prepositive electromagnetic tablet with a transparent antenna comprises a durable transparent substrate, a transparent antenna layer, and a transparent protective layer. According to this invention, an electromagnetic tablet can be integrated to LCD. Therefore, by employing the electromagnetic tablet according to this invention, it is more efficient for user to perform the function of hand-written input, hand-written drawing, and so on.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 is a diagram showing an electromagnetic tablet in prior art;

FIG. 2A is a diagram showing a prepositive electromagnetic tablet according to this present invention;

FIG. 2B is a diagram showing an electromagnetic tablet according to this invention;

FIG. 2C shows a layout of the transparent netted shielding layer of the prepositive electromagnetic tablet with transparent antenna in this invention;

FIG. 2D shows a layout of the transparent X/Y axis antenna layer of the prepositive electromagnetic tablet with transparent antenna in this invention; and

FIG. 3 is a schematic flow chart for fabricating the prepositive electromagnetic tablet with transparent antenna in this invention.

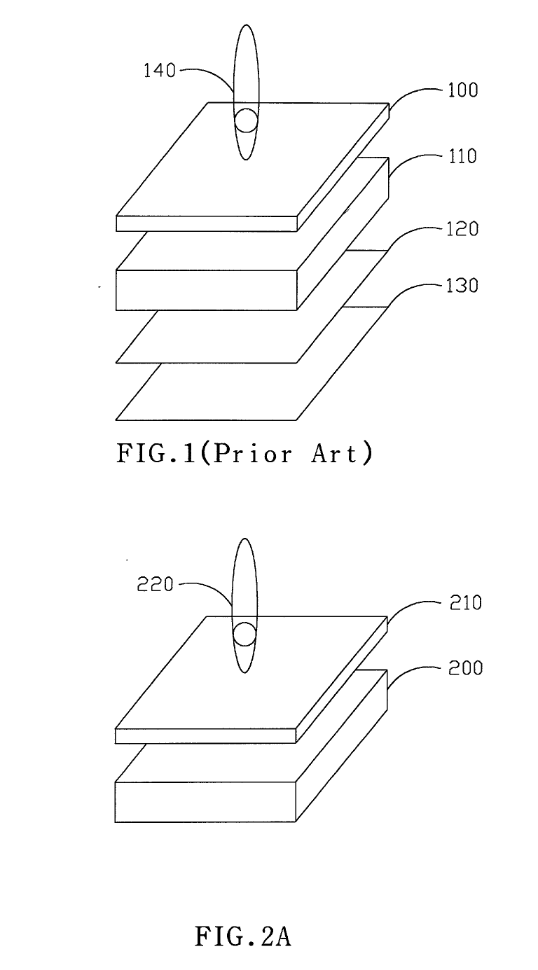

### DESCRIPTION OF THE PREFERRED EMBODIMENTS

Some sample embodiments of the invention will now be described in greater detail. Nevertheless, it should be recognized that the present invention can be practiced in a wide range of other embodiments besides those explicitly described, and the scope of the present invention is expressly not limited except as specified in the accompanying claims.

Hereinafter, the manufacturing of the members of this invention, such as baking, etching, printing, coating, and so on, is not the point of this invention, and the manufacturing process will not be illustrated in this application.

Then, the components of the semiconductor devices are not shown to scale. Some dimensions are exaggerated to the related components to provide a more clear description and comprehension of the present invention.

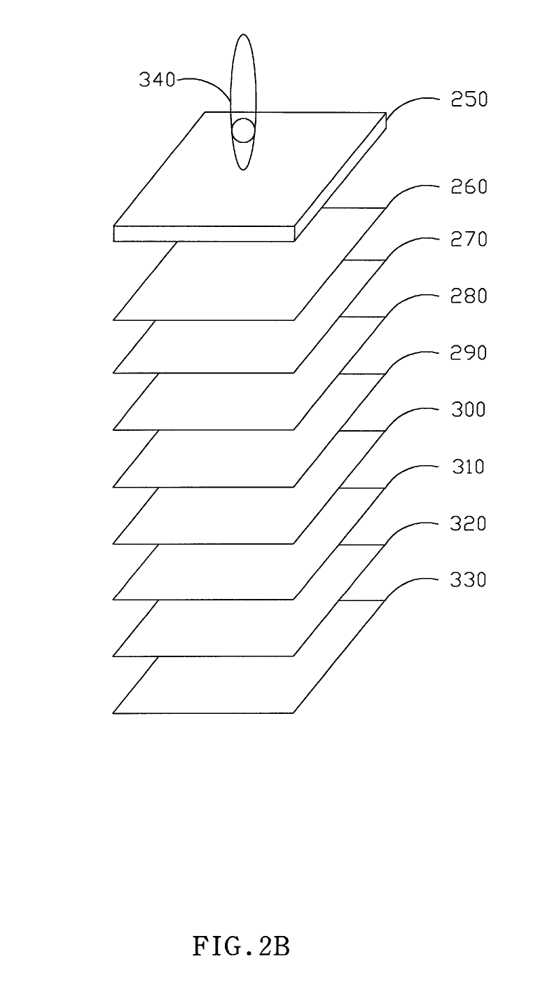

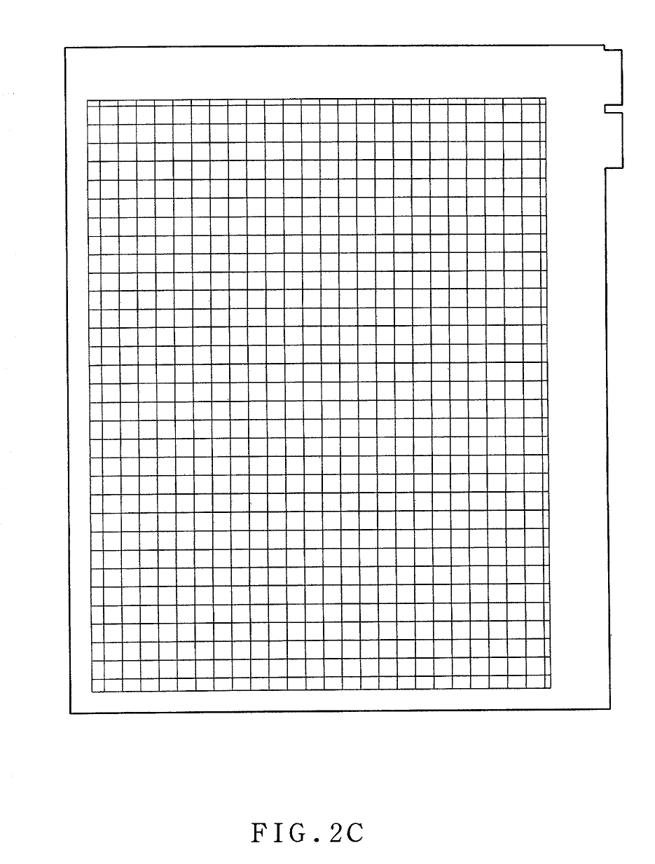

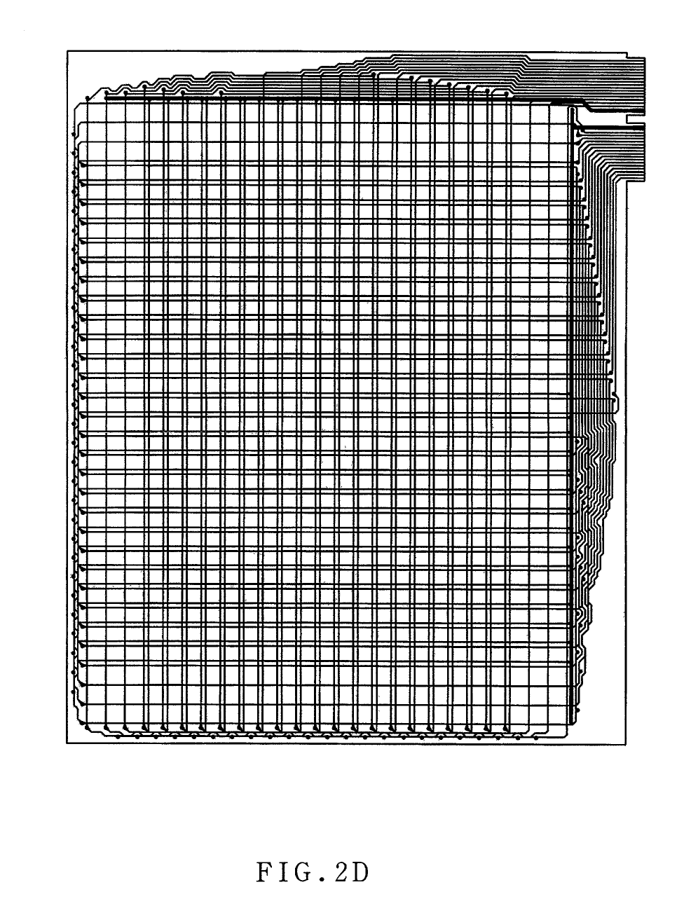

One preferred embodiment of this invention is about a prepositive electromagnetic tablet with a transparent antenna. The point of this embodiment is to apply the electromagnetic tablet on the surface of a durable transparent substrate 210, wherein the durable transparent substrate 210 is disposed in front of a LCD panel 200, as shown in FIG. 2A. That is, the electromagnetic tablet is disposed at the user's side of the LCD panel 200, and the problems due to the electromagnetic pen 220 distanced from the electromagnetic tablet in the prior art can be prevented by the construction of this invention. The construction of the prepositive electromagnetic tablet with a transparent antenna in this embodiment is described hereinafter.

As shown in FIG. 2B, a first transparent netted shielding layer 260 is disposed on one surface of a durable transparent substrate 250. The layout of the transparent netted shielding layers in this invention may be referred to, but are not limited to, FIG. 2C. The first transparent netted shielding layer 260 can isolate the electromagnetic wave interference within the environment, such as the electromagnetic wave from appliances, and to lower the background signal within the environment during the utilization of the electromagnetic tablet according to this invention. A first transparent insulating spacer 270 is disposed on the first transparent netted shielding layer 260. The first transparent insulating spacer 270 can prevent the first transparent netted shielding layer 260 electrically coupled with the antenna layer of the electromagnetic tablet in this embodiment. A first transparent conductive layer 280 is disposed on the first transparent insulating layer 270. The first transparent conductive layer 280 may be the X-axis/Y-axis antenna layer of the electromagnetic tablet in this embodiment for detecting the moving trace of an electromagnetic pen 340.

A secondary transparent insulating spacer 290 is disposed on the first transparent conductive layer 280. The secondary transparent insulating spacer 290 can prevent the unwanted electrical coupling between the X-axis antenna layer and the Y-axis antenna layer of the electromagnetic tablet in this embodiment. There is a secondary transparent conductive layer 300 disposed on the secondary transparent insulating spacer 290. The secondary transparent conductive layer 300 may be the Y-axis/X-axis antenna layer of the electromagnetic tablet in this embodiment. FIG. 2D is a schematic diagram of a layout of the X-axis and Y-axis antenna layers of the electromagnetic tablet according to this invention. A third transparent insulating spacer 310 and a secondary netted shielding layer 320 are disposed on the secondary transparent conductive layer 300. The layout of the secondary transparent netted isolated layer 320 can be referred to FIG. 2C. While utilizing the electromagnetic tablet according to this embodiment, the secondary netted isolating 320 can dampen the interference from the direction of the LCD panel, such as the electromagnetic wave from the transistors within the LCD. The third transparent insulating spacer 310 between the secondary transparent conductive layer 300 and the secondary transparent netted shielding layer 310 can prevent unwanted electrical coupling, present between the secondary transparent conductive layer 300 and the secondary transparent netted shielding layer 320. The construction of the electromagnetic tablet in this embodiment further comprises a transparent protective layer 330 disposed on the secondary transparent netted shielding layer 320. The transparent protective layer 330 can prevent the electromagnetic tablet in this embodiment from damage by an abrasion or bending.

One character of this embodiment is, the dimension of the transparent insulating spacers, including the first transparent insulating spacer 270, the secondary transparent insulating spacer 290, and the transparent insulating spacer 310, may not equal to the dimension of the surface of the durable transparent substrate 250. In other words, in order to increase the transparency of the electromagnetic tablet according to this invention, the insulating material of the above-mentioned transparent insulating spacers may be formed at the regions where some unwanted electrical coupling between the adjacent two layers will be carried out. Furthermore, depending on the interference level of the test of the electromagnetic tablet according to this invention, the layout of the first transparent netted shielding layer and the secondary transparent netted shielding layer, such as the size of the conductive line and the line width thereof, will be defined, and even one or both of the transparent isolating layers will be removed.

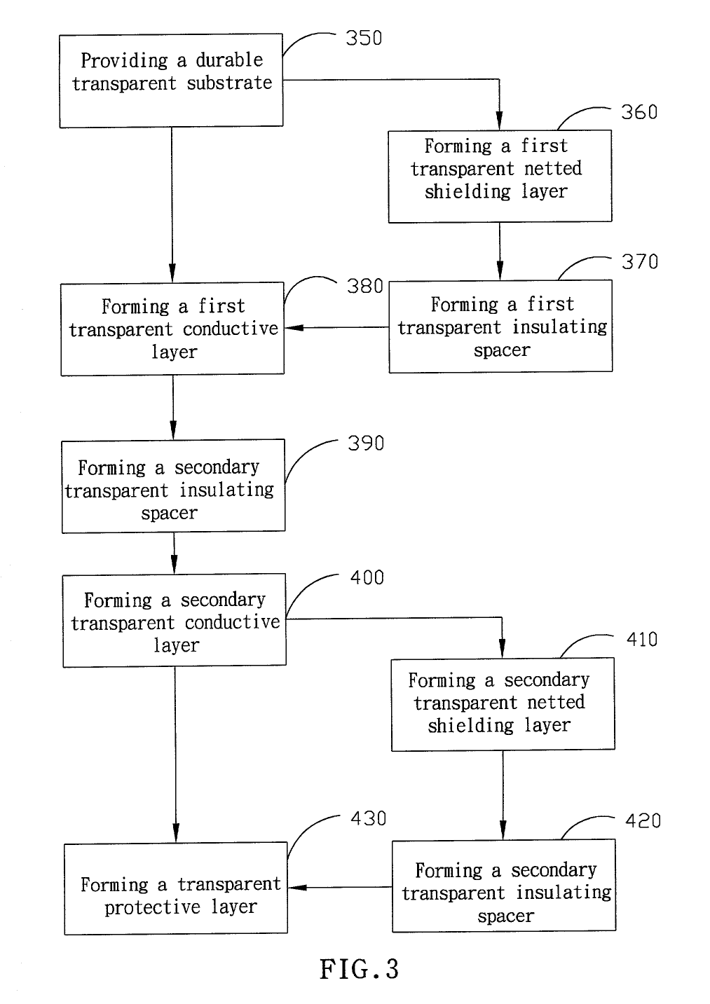

The secondary embodiment of this present invention is a method for fabricating a prepositive electromagnetic tablet with a transparent antenna. FIG. 3 is a flow chart of a prepositive electromagnetic tablet with a transparent antenna according to the present invention. At first, a transparent substrate is provided, wherein the transparent substrate may be a durable transparent substrate, as shown in step 350, and the antenna layers in this embodiment can be printed onto the durable transparent substrate. The durable transparency is consisted of glass, or like material. Transparent materials, such as ITO, are employed to form a first transparent conductive layer onto the durable transparent substrate (as step 380). A conventional process, such as a circuit printing process forms the first transparent conductive layer. The first transparent conductive layer may be the X-axis antenna (or the Y-axis antenna) of the electromagnetic tablet according to this invention for detecting the position and the moving trace of an electromagnetic pen.

To avoid the unwanted electrical coupling between the X-axis antenna and the Y-axis antenna of the electromagnetic tablet according to this invention, following the first transparent conductive layer formed onto the durable transparent substrate, a transparent insulating spacer (referred to the secondary insulating spacer hereinafter) is formed onto the first transparent conductive layer, as shown in step 390. After forming the transparent insulating spacer, a secondary transparent conductive layer is formed onto the transparent insulating spacer (as step 400) by a process in the prior art, such as a circuit printing process. The secondary conductive layer is made of a transparent material, ex. ITO. The secondary transparent conductive layer may be the Y-axis antenna (or the X-axis antenna) of the electromagnetic tablet according to this present invention for detecting the position and the moving trace of the electromagnetic pen. Finally, a transparent protective layer is formed onto the secondary transparent conductive layer as a Y-axis antenna in this embodiment, as step 430, for keeping the electromagnetic tablet according to this invention, including the layers disposed on the durable transparent substrate, from suffering damage of abrasion and the like. The transparent protective layer may be consisted of a transparent polymer, such as polyethylene terephthalate (PET).

In the secondary embodiment, in order to lower the interference within the environment while utilizing the electromagnetic tablet according to this invention, another two steps may be added before the step of forming the first transparent conductive layer. The above-mentioned two steps are step 360 for forming a first transparent netted shielding layer onto the durable transparent substrate, and step 370 for forming a first transparent insulating spacer. After forming the first transparent insulating spacer, the first transparent conductive layer is formed onto the first transparent insulating spacer. The first transparent netted shielding layer is made of a transparent material, ex. ITO. The first transparent netted shielding layer can avoid the unwanted electrical coupling, such as a short, present between the first transparent conductive layer and the first transparent netted shielding layer.

The electromagnetic tablet according to this present invention can be applied in front of a monitor. For example, the electromagnetic tablet can be disposed in front of a LCD panel (at the user's side) to form a tablet integrated type LCD. Therefore, in keeping the electromagnetic tablet from interference of the monitor/LCD, another two steps may be added before the step of forming the transparent protective payer. One of the above-mentioned is the step 410 for forming a third transparent insulating spacer onto the secondary transparent conductive layer, and the other step is the step 420 for forming a secondary transparent netted shielding layer onto the third transparent insulating spacer. The above-mentioned secondary transparent netted shielding layer is made of a transparent material, such as ITO. The above-mentioned third transparent insulating spacer can avoid the unwanted electrical coupling between the secondary transparent netted shielding layer and the secondary transparent conductive layer.

In this secondary embodiment, the additive steps for forming the first transparent netted shielding layer (and the secondary transparent insulating spacer) and the secondary transparent netted shielding layer (and the third transparent insulating spacer) will be preformed or removed depending on the interference level in the test of the electromagnetic tablet according to this invention. Furthermore, the layout of the transparent netted shielding layers will also be adjustable by the above-mentioned interference level in the test.

Additionally, in the above-mentioned secondary embodiment, the dimension of each of the transparent insulating spacers may not be equal to the dimension of the durable transparent substrate. For fabricating an electromagnetic tablet with better transparency, each of the above-mentioned transparent insulating spacers can be formed at the regions where the unwanted electrical coupling, such as a short, is carried out between the adjacent layers.

In the above-mentioned embodiments of this invention, the transparent antenna layers, the transparent insulating spacers, and the transparent netted shielding layers of the electromagnetic tablet may be fabricated at the user's side or the displayer's side of the durable transparent substrate. Because the aforementioned layers of the electromagnetic tablet according to this invention are disposed between a durable transparent substrate and a transparent protective layer, no matter which side of the durable transparent substrate the aforementioned layers will be formed, the aforementioned layers of the electromagnetic tablet will not suffer damage of the electromagnetic pen.

According to the above-mentioned embodiments, this present invention discloses a prepositive electromagnetic tablet with transparent antenna wherein the electromagnetic tablet is applied in front of the LCD (at the user's side of the displayer). The character of this invention is integrating electromagnetic tablet and displayer under the tide of high integration. Through integrating an electromagnetic tablet and a displayer, a user can directly perform a hand-written input, hand-written drawing, and any like function on the electromagnetic tablet integrated type monitor according to this invention. Hence, the electromagnetic tablet is not only rising the utility of a displayer, but also more closed to the writing habit of user. In other words, the electromagnetic tablet is a more practical tool.

Although specific embodiments have been illustrated and described, it will be obvious to those skilled in the art that various modifications may be made without departing from what is intended to be limited solely by the appended claims.

What is claimed is:

1. A structure of a prepositive electromagnetic tablet with transparent antenna, comprising:
a transparent substrate;
a first transparent conductive layer disposed on said transparent substrate, wherein said first transparent conductive layer can detect moving trace of a electromagnetic pen by electromagnetic wave;
a first transparent insulating spacer disposed on said first transparent conductive layer;
a secondary transparent conductive layer disposed on said first transparent insulating spacer, wherein said secondary transparent conductive layer can detect moving trace of the electromagnetic pen by electromagnetic wave; and
a transparent protective layer disposed on said secondary transparent conductive layer.

2. The structure according to claim 1, wherein the electromagnetic tablet further comprises a first transparent netted shielding layer disposed between said transparent substrate and said first transparent conductive layer.

3. The structure according to claim 2, wherein the electromagnetic tablet further comprises a secondary transparent insulating spacer disposed between said first transparent netted shielding layer and said first transparent conductive layer.

4. The structure according to claim 3, wherein said secondary transparent insulating spacer is formed at the regions where unwanted electrical coupling is occurred between said first transparent netted shielding layer and said transparent conductive layer.

5. The structure according to claim 1, wherein said first transparent insulating spacer is formed at the regions where unwanted electrical coupling is occurred between said first transparent conductive layer and said transparent conductive layer.

6. The structure according to claim 1, wherein the electromagnetic tablet further comprises a secondary transparent netted shielding layer disposed between said transparent protective layer and said secondary transparent conductive layer.

7. The structure according to claim 6, wherein the electromagnetic tablet further comprises a third transparent insulating spacer disposed between the said transparent protective layer and said secondary transparent netted shielding layer.

8. The structure according to claim 7, wherein said third transparent insulating spacer is formed at the regions where unwanted electrical coupling is occurred between said secondary transparent conductive layer and said secondary transparent netted shielding layer.

9. The structure according to claim 1, wherein said transparent substrate is applied in front of LCD.

10. A method for fabricating a prepositive electromagnetic tablet with transparent antenna, comprising:
providing a transparent substrate;
forming a first transparent conductive layer onto said transparent, wherein said first transparent conductive layer can detect moving trace of a electromagnetic pen by electromagnetic wave;
fabricating a first transparent insulating spacer onto said first transparent conductive layer;
forming a secondary transparent conductive layer onto said first transparent insulating spacer, wherein said secondary transparent conductive layer can detect moving trace of the electromagnetic pen by electromagnetic wave; and
forming a transparent protective layer onto said secondary transparent conductive layer.

11. The method according to claim 10, wherein said first transparent insulating spacer is formed at the regions where unwanted electrical coupling is occurred between said first transparent conductive layer and said transparent conductive layer.

12. The method according to claim 10, wherein the method further comprises a step for forming a first transparent netted shielding layer onto said transparent substrate, before the step for forming said first transparent conductive layer.

13. The method according to claim 12, wherein the method further comprises a step, before the step for forming said first transparent conductive layer, for forming a secondary transparent insulating spacer onto said first transparent netted shielding layer.

14. The method according to claim 13, wherein said secondary transparent insulating spacer is fabricated at the regions where unwanted electrical coupling is occurred between said first transparent netted shielding layer and said first transparent conductive layer.

15. The method according to claim 10, wherein the method further comprises a step for forming a secondary transparent netted shielding layer onto said secondary transparent netted shielding layer, before the step for forming said transparent protective layer.

16. The method according to claim 15, wherein the method further comprises a step, before the step for forming said secondary transparent netted shielding layer, for forming a third transparent insulating spacer onto said secondary transparent conductive layer.

17. The method according to claim 16, wherein said third transparent insulating spacer is fabricated at the regions where unwanted electrical coupling is occurred between said secondary transparent netted shielding layer and said transparent conductive layer.
